(19) United States
(12) Patent Application Publication
(10) Pub. No.: US 2007/0220524 A1
(43) Pub. Date: Sep. 20, 2007

(54) Apparatus and method to manage system by processes using process data record

(75) Inventor: Jee-hye Cha, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/703,132

(22) Filed: Feb. 7, 2007

(30) Foreign Application Priority Data
Mar. 14, 2006 (KR) 2006-23635

(51) Int. Cl. G06F 9/46

(52) U.S. Cl. 718/104

(57) ABSTRACT

An apparatus and method to manage a system by processes using a Process Data Record (PDR), the apparatus comprising the PDR that stores predetermined information of a process; a state-checking unit to check for an event occurrence by comparing a critical value stored in the PDR with a resource utilization rate of the process; and an event-handling unit to handle an event of the process, if the event occurs, based on an event-handling method defined in the PDR.

### CROSS-REFERENCE TO RELATED APPLICATION

This application is based on and claims priority from Korean Patent Application No. 2006-23635 filed on Mar. 14, 2006 in the Korean Intellectual Property Office, the disclosure of which is incorporated herein by reference.

### BACKGROUND OF THE INVENTION

1. Field of the Invention

Aspects of the present invention relate to managing a system by processes using a Process Data Record (PDR). More particularly, aspects of the present invention relate to an apparatus and method to manage a system by processes using a Process Data Record (PDR), which effectively and stably manages the system.

2. Description of the Related Art

Conventional system resource management software programs do not monitor a resource utilization of each software program (such as a service, an application, and a separate process), but monitor a utilization of each resource used by the total system. As such, in the case where a certain resource utilization rate exceeds a certain level, a recovery is executed for the total system.

For example, as a result of monitoring the CPU utilization of the total system, if the CPU utilization rate exceeds a certain level, the rate is recovered by restarting the system. Furthermore, as a result of monitoring the memory utilization of the total system, if the memory utilization rate of the total system exceeds a certain level, the memory space is secured by restarting the system. Likewise, in the case where the CPU or the memory utilization rate exceeds a certain level (i.e., an event occurrence), such an event is usually handled by restarting the system because the software program that caused the increase in the utilization rate cannot be determined.

Hence, all software programs that are operated in the system stop, and the operating system is restarted. As such, the recovery method may significantly harm the system, a remote system connected to the system, and the software programs.

Korean Unexamined Patent 2002-040477 (Method for Managing Multi Process in Computer System) discloses a multi-process management method in which state information of management object processes are quickly acquired by acquiring state information of each management object process in a process state management table that stores the processes' own state information according to state information request signals transmitted from the management process. However, this disclosure does not mention a technology that manages and handles a generated problem (i.e., an event).

### SUMMARY OF THE INVENTION

Aspects of the present invention provide a method and apparatus to manage a system efficiently and stably by managing a system by processes. Aspects of the present invention also provide a method and apparatus to handle events using an event-handling method defined in a Process Data Record (PDR).

According to an aspect of the present invention, there is provided an apparatus to manage a system by processes, the apparatus comprising: a PDR to store a plurality of information on each of one or more processes; a state-checking unit to compare a critical value stored in the PDR with a resource utilization rate of each of the one or more processes; and an event-handling unit to handle an event of a first process based on an event-handling method defined in the PDR, if the state-checking unit determines that the resource utilization rate of the first process exceeds the corresponding critical value of the first process.

According to another aspect of the present invention, there is provided a method of managing a system by processes using a PDR, the method comprising checking a resource utilization rate of a predetermined process; comparing the resource utilization rate of the predetermined process to a critical value of the predetermined process stored in the PDR; requesting an event-handling of the predetermined process if the resource utilization rate is greater than the critical value; and handling an event of the predetermined process based on an event-handling method defined in the PDR according to the event-handling request.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus to manage a system by processes using Process Data Record (PDR) according to an embodiment of the present invention.

FIGS. 2A and 2B illustrate process information stored in a PDR in an apparatus to manage a system by processes using the PDR and a table thereof according to an embodiment of the present invention.

FIG. 3 is a flowchart illustrating a method of managing a system by processes using a PDR according to an embodiment of the present invention.

FIGS. 4A and 4B illustrate an operation of an apparatus to manage a system by processes using a PDR according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention are described hereinafter with reference to flowchart illustrations of user interfaces, methods, and computer program products according to embodiments of the invention. It should be understood that each block of the flowchart illustrations and combinations of blocks in the flowchart illustrations can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create devices to implement the operations specified in the flowchart block or blocks.

These computer program instructions may also be stored in a computer-usable or computer-readable memory that can direct a computer or other programmable data processing apparatus to function in a particular manner, such that the instructions stored in the computer-usable or computer-readable memory produce an article of manufacture including instructions that implement the function specified in the flowchart block or blocks.

The computer program instructions may also be loaded into a computer or other programmable data processing apparatus to cause a series of operations to be performed in the computer or other programmable apparatus to produce a computer-implemented process such that the instructions that execute on the computer or other programmable apparatus provide operations to implement the functions specified in the flowchart block or blocks.

And each block of the flowchart illustrations may represent a module, segment, or portion of code, which includes one or more executable instructions to implement the specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

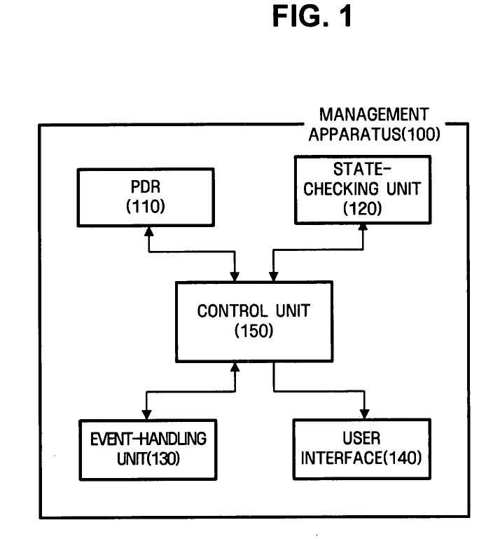

FIG. 1 is a block diagram of an apparatus to manage a system by processes using a Process Data Record (PDR) 110 according to an embodiment of the present invention. As illustrated, the apparatus to manage a system by processes using the PDR 110 includes a PDR 110, a state-checking unit 120, an event-handling unit 130, a user interface 140, and a control unit 150.

The term “unit” refers to a hardware element, such as a Field Programmable Gate Array (FPGA) or an Application Specific Integrated Circuit (ASIC), that executes certain roles. Each unit can exist in addressable storage media, or can be constituted to regenerate one or more processors. For example, a unit can include software elements, object-oriented software elements, class elements, task elements, processes, functions, attributes, procedures, circuits, data, database, data structures, tables, arrays, and variables. Elements and functions provided in the units can be combined into fewer elements or units, or can be divided into additional elements and units.

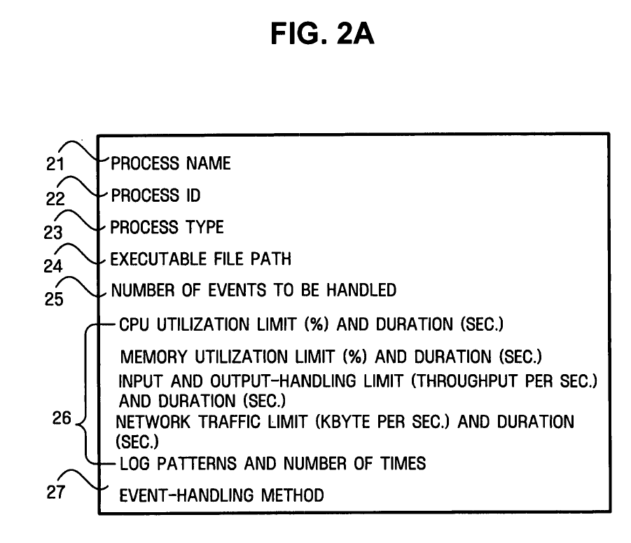

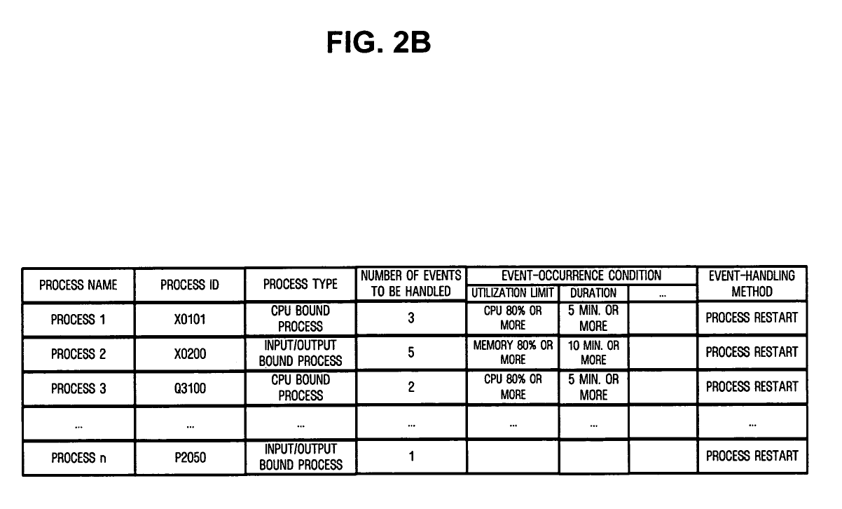

The PDR 110 includes various information on predetermined processes in a table. For example, the information stored in the PDR 110 may include a process name, a process ID, a process type, an executable file path, the number of event-handling actions, the condition of event occurrence, and an event-handling method. Here, the process information stored in the PDR 110 may be encrypted in order to prevent arbitrary changes to the information. The information stored in the PDR 110 will be described with reference to FIGS. 2A and 2B.

Further, the process information stored in the PDR 110 includes basic values when setting a new process, although a setting value (e.g., a critical value such as for the event occurrence condition) stored by a user can be changed in order to effectively manage each process. Here, the critical value stored in the PDR 110 can be set differently by each process.

The state-checking unit 120 checks the resource utilization rate per predetermined period, and checks an event occurrence by comparing the resource utilization rate and the critical value stored in the PDR 110. In the case where an event occurrence condition is satisfied, the event occurrence information is transmitted to the control unit 150. Here, a number of events to be handled is a number of times that an event needs to be handled.

The event-handling unit 130 handles an event based on an event handling method defined in the PDR 110 if an event occurs in a predetermined process. Here, the event-handling unit 130 handles the event for each process, not for the total system.

The user interface 140 provides a menu screen for environment setting for the convenience of a user. The user can set and change a critical value on the event-occurrence condition of each process in the menu screen. Further, the user interface 140 displays whether events checked by the state-checking unit 120 have been handled. According to an aspect of the present invention, in the case where a user restarts a system because of an event occurrence in a specific process, a message, such as “Process 1 is restarted” or “System is restarted,” is displayed.

If the information on the event handling request and the number of events to be handled is transmitted from the state-checking unit 120, the control unit 150 determines whether the event handling by processes or for the system (i.e., restarting the system) is necessary by checking the number of events to be handled. Here, the number of events to be handled is set per process, and the control unit 150 decreases the number by 1 whenever an event is handled. If the number of events to be handled is not 0, the control unit 150 requests an event handling on a predetermined process from the event-handling unit 130. If the number of events to be handled is 0, the control unit restarts the system.

Furthermore, the control unit 150 controls the operations of the PDR 110, the state-checking unit 120, the event-handling unit 130, and the user interface 140.

According to an aspect of the present invention, the apparatus 100 can provide an alarming function on an added process if a new process is set.

FIGS. 2A and 2B illustrate process information stored in a PDR 110 in an apparatus to manage a system by processes using the PDR 110 and a table thereof according to an embodiment of the present invention.

As illustrated in FIG. 2A, the PDR 110 stores various information for each process. According to an aspect of the present invention, the PDR 110 stores a process name 21, a process ID 22, a process type 23, an executable file path 24, a number of events to be handled 25, an event occurrence condition 26, and an event-handling method 27.

The process type 23 specifies characteristics of a process such as a process level and characteristics of the work. Here, process levels may include a system process, a process executed along with the operating system, a sub-process of a certain process, and a general application. The characteristics of the process work may include a CPU bound process and an input and output bound process, although not limited thereto.

The event occurrence condition 26 is a predetermined critical value that can be set differently for each process and can be arbitrarily changed by a user. For example, the event occurrence condition 26 includes critical values on the CPU utilization limit and the duration that has exceeded the limit, the memory utilization limit and the duration that has exceeded the limit, the input-and-output handling limit and the duration that has exceeded the limit, the network-traffic limit and the duration that has exceeded the limit, and the log pattern and the number of log patterns occurred, etc.

Referring to FIG. 2B, the event occurrence condition 26 for, for example, process 1 is 80% of the CPU utilization limit, and the duration that exceeds the limit is 5 minutes. The state-checking unit 120 checks the state of process 1 per predetermined time, and if the event occurrence condition 26 is satisfied (e.g., 85% CPU utilization rate and 7 minute duration), the state-checking unit 120 requests the control unit 150 to handle the event according to the event-handling method 27.

As illustrated in FIG. 2B, the PDR 110 stores various information for each process in a table. Here, the information stored in the PDR 110 may be encrypted to prevent arbitrary changes to the information. For example, for process 1, the PDR 110 stores a process ID 22 (e.g., X0101), a process type 22 (e.g., CPU bound process), the number of events to be handled 25 (e.g., 3), an event occurrence condition 26 (e.g., CPU utilization limit 80%, duration 5 min.), and an event-handling method 27 (e.g., a process restart).

Hence, the state-checking unit 120 checks the state of each process, compares the state with the stored event occurrence condition 26, and transmits the result to the control unit 150. If an event has occurred, the control unit 150 requests the event-handling unit 130 to handle the event. As such, the event-handling unit 130 handles the event based on the event-handling method 27 in the PDR 110. As a result, a recovery can be performed for each process when an event has occurred.

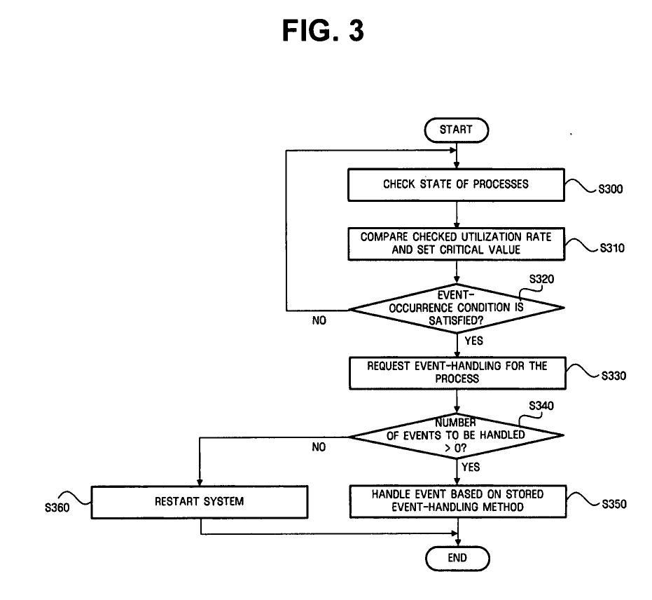

FIG. 3 is a flowchart illustrating a method of managing a system by processes using a PDR 110 according to an embodiment of the present invention. First, the state-checking unit 120 checks the state for each process in operation S300. Here, the checking refers to checking the current resource utilization rate of a process.

Next, the state-checking unit 120 compares the resource utilization rate of a checked, predetermined process (e.g., process 1) with the critical value set according to the event occurrence condition 26 of the process stored in the PDR 110 (operation S310).

If, in operation S320, the resource utilization rate is greater than the set critical value (i.e., if the event occurrence condition 26 is satisfied), the state-checking unit 120 requests the control unit 150 to handle the event in operation S330. Here, information about the number of events to be handled may also be transmitted to the control unit 150.

Next, the control unit 150 checks the transmitted number of events to be handled. If the number is greater than 0 (operation S340), the control unit 150 requests the event-handling unit 130 to handle the event. Then, if the event is handled by the event-handling unit 130, the control unit 150 decreases the number of events to be handled by 1.

The event-handling unit 130 handles the event of the process based on the event-handling method 27 of the process stored in the PDR 110 (operation S350). According to an aspect of the present invention, the control unit 150 displays that the process is restarted through the user interface 140 before the event is handled.

Further, if the resource utilization value of the checked process is less than the set critical value (i.e., the event occurrence condition 26 is not satisfied) in operation S320, the state-checking unit 120 repeatedly checks the state for each process per predetermined time until, for example, the event occurrence condition 26 is satisfied.

Further, if the number of events to be handled is 0 in operation S340, the control unit 150 restarts the system in operation S360. Here, the control unit 150 displays that the system is restarted through the user interface 140 before restarting the system.

Hence, because only the event for the process where an event has occurred is handled by checking the event occurrence for each process, other processes are normally operated.

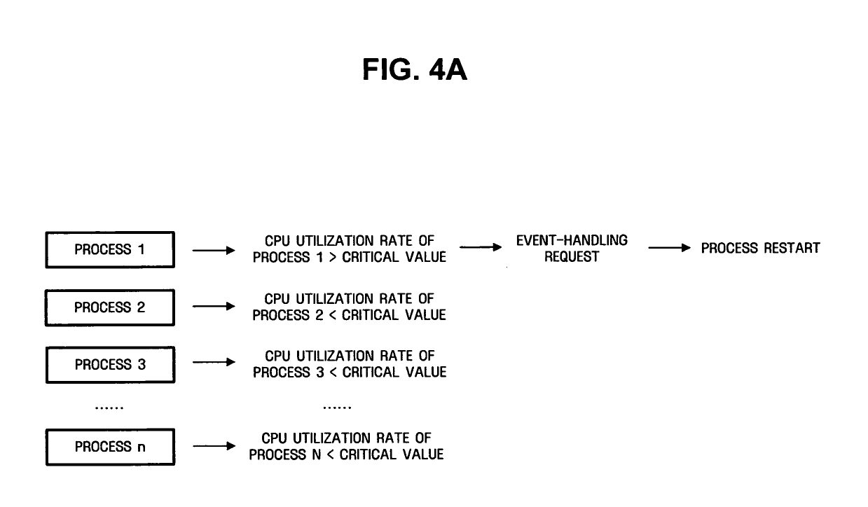

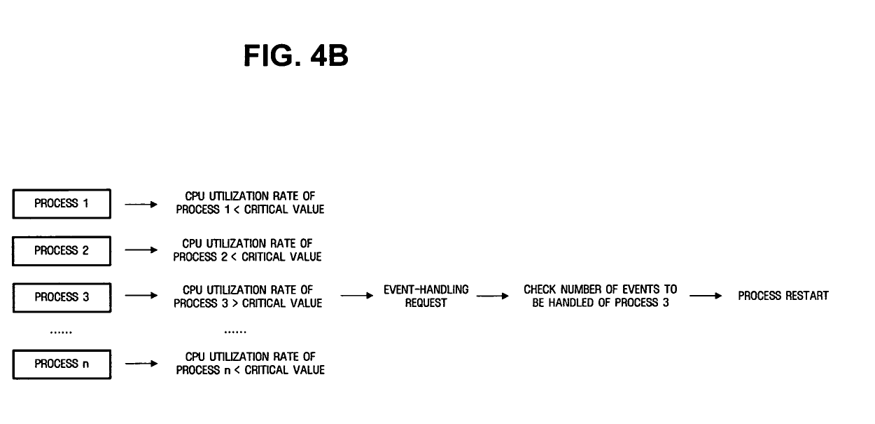

FIGS. 4A and 4B illustrate the operation of an apparatus to manage a system by processes using a PDR 110 according to an embodiment of the present invention. As illustrated in FIG. 4A, there are multiple processes (process 1 to process n), which are individually operating, and the state-checking unit 120 checks the state of each process per predetermined period. The CPU utilization rate of process 1 is greater than the critical value set in the PDR 110, and the CPU utilization rates of process 2, process 3, and process n are less than the critical value set in the PDR 110. As such, the state-checking unit 120 determines that the CPU utilization rate of process 1 satisfies the event occurrence condition 26, and thus requests from the control unit 150 the event handling of process 1.

Then, the control unit 150 requests the event handling of process 1 from the event-handling unit 130. Here, the control unit 150 may display that process 1 is restarted through the user interface 140 before the event-handling unit 130 handles the event. Then, the event-handling unit handles the event based on the event-handling method 27 (e.g., the process restart) of the set process 1, and thus the CPU utilization rate is recovered.

As illustrated in FIG. 4B, multiple processes (process 1 to process n) may be individually operating, and the state-checking unit 120 checks the state of each process per predetermined period. The CPU utilization rate of process 3 is greater than the critical value set in the PDR 110, and the CPU utilization rates of process 1, process 2, and process n are less than the critical value set in the PDR 110. As such, the state-checking unit 120 determines that the CPU utilization of process 3 satisfies the event occurrence condition 26, and requests the event handling of process 3.

Then, the control unit 150 checks the number of events to be handled for process 3, and if the number is greater than 0, requests the event handling of process 3 from the event-handling unit 130. Here, the control unit 150 may display that process 3 is restarted through the user interface 140 before handling the event. Then, the event-handling unit 130 handles the event based on the event-handling method 27 (e.g., the process restart) of process 3 set in the PDR 110, and thus the memory space of process 3 is secured. According to an aspect of the present invention, if the number of events to be handled is 0, the system is restarted.

Aspects of the present invention have the following advantages. First, the event occurrence of each process is checked per predetermined time, and events are thus handled by each process such that the resource utilization of each of the processes is efficiently managed. Second, individual processes can be managed by applying the concept of a critical value in software, and errors in the software program can therefore be sensed. Third, by freely constituting a PDR 110, a reasonable and efficient resource utilization management system for each system can be established. Fourth, by handling only processes having errors, the risk and the cost for the recovery are reduced compared with the case where the total system is handled. Fifth, the system operation time can be extended, minimizing service interruptions due to errors in software.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to manage a system by processes, the apparatus comprising:
a Process Data Record (PDR) to store a plurality of information on each of one or more processes;
a state-checking unit to compare a resource utilization rate of each of the one or more processes with a corresponding critical value, stored in the PDR, of each of the one or more processes; and
an event-handling unit to handle an event of a first process when the state-checking unit determines that the resource utilization rate of the first process exceeds the corresponding critical value of the first process.

2. The apparatus as claimed in claim 1, wherein the plurality of information stored in the PDR comprises process name information and event occurrence condition information.

3. The apparatus as claimed in claim 2, wherein the event occurrence condition information comprises the critical value such that the state-checking unit compares the resource utilization rate of each of the one or more processes with the corresponding event occurrence condition information stored in the PDR.

4. The apparatus as claimed in claim 2, wherein:
the event occurrence condition information comprises resource utilization limit information;
the state-checking unit compares the resource utilization rate of each of the one or more processes with the corresponding resource utilization limit information stored in the PDR; and
the event-handling unit handles the event of the first process when the state-checking unit determines that the resource utilization rate of the first process exceeds the corresponding resource utilization limit information of the first process stored in the PDR.

5. The apparatus as claimed in claim 2, wherein:
the event occurrence condition information comprises resource utilization limit information and duration information;
the state-checking unit compares the resource utilization rate of each of the one or more processes with the corresponding resource utilization limit information stored in the PDR;
the state-checking unit compares a duration of time that the resource utilization rate of the first process exceeds the corresponding resource utilization limit information to a corresponding duration stored in the duration information, when the resource utilization rate of the first process exceeds the corresponding resource utilization limit information; and
the event-handling unit handles the event of the first process when the state-checking unit determines that the duration of time exceeds the corresponding duration stored in the duration information.

6. The apparatus as claimed in claim 2, wherein:
the plurality of information stored in the PDR further comprises event handling method information; and
the event-handling unit handles the event of the first process according to the event handling method information corresponding to the first process in the PDR when the state-checking unit determines that the resource utilization rate of the first process exceeds the corresponding critical value of the first process.

7. The apparatus as claimed in claim 2, wherein the plurality of information stored in the PDR further comprises process ID information, process type information, executable file path information, and information on a number of events to be handled.

8. The apparatus as claimed in claim 1, wherein the PDR stores the plurality of information on each of the one or more processes in a table.

9. The apparatus as claimed in claim 6, further comprising:
a control unit to check a number of events to be handled for the first process when the state-checking unit determines that the resource utilization rate of the first process exceeds the corresponding critical value of the first process, wherein:
if the number of events to be handled for the first process is greater than zero, then the control unit controls the event-handling unit to handle the event of the first process according to the event handling method information corresponding to the first process in the PDR; and
if the number of events to be handled for the first process is zero, then the control unit controls the apparatus to perform a system event.

10. The apparatus as claimed in claim 9, wherein the system event is a system restart.

11. The apparatus as claimed in claim 9, wherein the number of events to be handled is stored in the PDR.

12. The apparatus as claimed in claim 1, wherein the event is a process restart.

13. The apparatus as claimed in claim 1, further comprising:
a control unit to check a number of events to be handled for the first process when the state-checking unit determines that the resource utilization rate of the first process exceeds the corresponding critical value of the first process, wherein:
if the number of events to be handled for the first process is greater than a predetermined value, then the control unit controls the event-handling unit to handle the event of the first process; and
if the number of events to be handled for the first process equal to or less than the predetermined value, then the control unit controls the apparatus to perform a system event.

14. The apparatus as claimed in claim 13, wherein the predetermined value is zero.

15. A method of managing a system by processes using a PDR, the method comprising:
checking a resource utilization rate of a predetermined process;
comparing the resource utilization rate of the predetermined process to a critical value of the predetermined process stored in the PDR; and
handling an event of the predetermined process when the resource utilization rate of the predetermined process exceeds the critical value.

16. The method as claimed in claim 15, wherein the handling of the event comprises:
requesting an event handling of the predetermined process when the resource utilization rate of the predetermined process exceeds the critical value; and
handling the event of the predetermined process according to the requesting of the event handling of the predetermined process.

17. The method as claimed in claim 15, wherein the handling of the event comprises:
handling the event according to an event handling method of the predetermined process stored in the PDR.

18. The method as claimed in claim 15, further comprising:
checking a number of events to be handled for the predetermined process when the resource utilization rate of the predetermined process exceeds the critical value, wherein
the handling of the event comprises:
handling the event of the predetermined process if the checked number of events to be handled is greater than a predetermined value; and
handling a system event if the checked number of events to be handled is less than the predetermined value.

19. The method as claimed in claim 18, wherein the system event is a system restart.

20. The method as claimed in claim 18, wherein the predetermined value is zero.

21. The method as claimed in claim 18, wherein the number of events to be handled is stored in the PDR.

22. The method as claimed in claim 15, wherein the event is a process restart.

23. The method as claimed in claim 18, wherein the handling the event of the predetermined process if the checked number of events to be handled is greater than a predetermined value comprises handling the event according to an event handling method of the predetermined process stored in the PDR.

24. The method as claimed in claim 15, further comprising:
displaying information on the handling of the event of the predetermined process.

25. A method of managing a system by processes, the method comprising:
storing a plurality of information on each of one or more processes in a PDR;
checking a resource utilization rate of a first process;
comparing the resource utilization rate of the first process to a critical value of the first process stored in the PDR; and
handling an event of the first process when the resource utilization rate of the first process exceeds the critical value.

26. The method as claimed in claim 25, wherein the plurality of information stored in the PDR comprises process name information and event-occurrence condition information.

27. The method as claimed in claim 26, wherein:
the event occurrence condition information comprises the critical value; and
the comparing of the resource utilization rate comprises comparing the resource utilization rate of the first process to the corresponding event occurrence condition information stored in the PDR.

28. The method as claimed in claim 26, wherein:
the event occurrence condition information comprises resource utilization limit information;
the comparing of the resource utilization rate comprises comparing the resource utilization rate of the first process to the corresponding resource utilization limit information stored in the PDR; and
the handling of the event comprises handling the event of the first process when the resource utilization rate of the first process exceeds the corresponding resource utilization limit information of the first process stored in the PDR.

29. The method as claimed in claim 26, wherein:
the event occurrence condition information comprises resource utilization limit information and duration information;
the comparing of the resource utilization rate comprises comparing the resource utilization rate of the first process to the corresponding resource utilization limit information stored in the PDR, and comparing a duration of time that the resource utilization rate of the first process exceeds the corresponding resource utilization limit information to a corresponding duration stored in the duration information; and
the handling of the event comprises handling the event of the first process when the resource utilization rate of the first process exceeds the corresponding resource utilization limit information of the first process stored in the PDR and the duration of time exceeds the corresponding duration stored in the duration information.

30. The method as claimed in claim 25, wherein the handling of the event comprises:
handling the event according to an event handling method of the first process stored in the PDR.

31. The method as claimed in claim 25, further comprising:
checking a number of events to be handled for the first process when the resource utilization rate of the first process exceeds the critical value, wherein
the handling of the event comprises:
handling the event of the first process if the checked number of events to be handled is greater than a predetermined value; and
handling a system event if the checked number of events to be handled is less than the predetermined value.

32. The method as claimed in claim 31, wherein the system event is a system restart.

33. The method as claimed in claim 31, wherein the predetermined value is zero.

34. The method as claimed in claim 31, wherein the number of events to be handled is stored in the PDR.

35. The method as claimed in claim 25, wherein the event is a process restart.

36. The method as claimed in claim 25, wherein the PDR stores the plurality of information on each of one or more processes in a table.
